(19) United States
(12) Patent Application Publication
(10) Pub. No.: US 2023/0284572 A1
(43) Pub. Date: Sep. 14, 2023

(54) Mobile Oceanic Water Upwelling Device and Method

(71) Applicants: Anton Perry Alferness, Irvine, CA (US); Clifton A Alferness, Olalla, WA (US)

(72) Inventors: Anton Perry Alferness, Irvine, CA (US); Clifton A Alferness, Olalla, WA (US)

(21) Appl. No.: 17/689,822

(22) Filed: Mar. 8, 2022

(51) Int. Cl. A01G 15/00

(52) U.S. Cl. CPC A01G 15/00

(57) ABSTRACT

This invention provides a device and method for upwelling large amounts of cool, nutrient rich water by moving or pulling the device behind surface or subsurface marine vehicles to cool and/or enrich the surface and near-surface waters of selected oceanic regions. This invention also provides a device to upwell cool oceanic water from depth and use it to propel a vessel. This invention also provides a method for altering the course or intensity of cyclonic storms to reduce human and property damage from such storms by selective cooling of regions of ocean surface. This invention also provides a device and method for augmentation of the natural coastal upwelling of vital nutrient rich waters.

### TECHNICAL FIELD

The present invention relates to ocean going marine vessels and equipment, and more particularly to technology for upwelling oceanic waters, and cooling and enriching surface waters.

### BACKGROUND

### Prior Art

Artificial upwelling of oceanic water is known in the prior art to cool and enrich surface waters. The following is a tabulation of prior art that appears relevant:

U. S. Patents

| Pat. No. | Issue Date | Patentee |
|---|---|---|
| 8348550 | Jan. 8, 2013 | Bowers, et al. |
| 8679331 | Mar. 25, 2014 | Bowers, et al. |
| 8685254 | Apr. 1, 2014 | Bowers, et al. |
| 8702982 | Apr. 22, 2014 | Bowers, et al. |
| 8715496 | May 6, 2014 | Bowers, et al. |
| 8602682 | Dec. 10, 2013 | Resler |
| 4326840 | Apr. 7, 1982 | Hicks, et al. |
| 10687481 | Jun. 23, 202 | Soloviev, et al. |
| 8882552 | Nov. 11, 2014 | Lambert |
| 8535107 | Sep. 17, 3013 | Lambert |
| 8033879 | Oct. 11, 2011 | Lambert |
| 4231312 | Nov. 4, 1980 | Person |

### NONPATENT LITERATURE DOCUMENTS

Greenhouse gas, upwelling-favorable winds, and the future of coastal ocean upwelling, ecosystems, Bakun, et al., 2010

Does It Make Sense to Modify Tropical Cyclones? A Decision-Analytic Assessment, Klima, et al., 2011

“Controlling hurricanes: Can hurricanes and other severe tropical storms be moderated or deflected?”, Ross N Hoffman, Scientific American, October 2004, pp 68-75

Experiments in Hurricane Modification, Simpson, et al., Research progress in artificial upwelling and its potential environmental effects, PAN YiWen, et al., Science China Dec. 9, 2015

Artificial upwelling using offshore wind energy for mariculture applications, Alvaro Viudez, et al., Scientia Marina, September 2016

An open ocean trial of controlled upwelling using wave pump technology, Angelique White, et al., American Meteorological Society, February 2010

Hurricane Suppression by Sea Surface Cooling, 2006 IEEE Long Island Systems, Applications and Technology Conference, R. LaRosa, 2006, pp. 1-5

Earth's mean temperature has been steadily increasing for many decades due to increasing concentrations of greenhouse gasses, such as carbon dioxide, in the atmosphere. Most of the heat trapped within the atmosphere in the past has been stored in the oceans throughout the world. As a result, the steadily increasing oceanic heat energy supply results in the formation and building of storms as they pass over these increasingly warming waters. This has and will result in increasing numbers of devastating cyclonic storms being formed in the tropical oceanic regions. Additionally, this warming has also increased the intensity of cyclonic ocean storms causing ever increasing destruction of onshore property and human suffering and death when these storms make landfall. In the United States alone, the cost of hurricane landfalls totals billions of dollars and many lives are lost each year.

Additionally, it is scientifically well established that coastal upwelling of deep oceanic water is responsible for much of the marine biome productivity of coastal areas. As oceanic currents approach, nutrient rich waters are pushed up onto the continental shelves. As these waters are mixed with surface waters, marine biome productivity improves. This increase in productivity from upwelling is also true of oceanic areas where deep water currents encounter underwater seamounts and bring cool, nutrient rich water up to the photic zone where sunlight can foster growth of photosynthetic biome. The warming of the earth's climate has thickened the warm upper layer of the oceans and reduced the natural effectivity of onshore upwelling of nutrient rich waters. Thus, there is a clear need for marine mobile systems that can enrich and/or cool selected oceanic regions by artificial upwelling.

### SUMMARY OF THE EMBODIMENTS

One embodiment includes an oceanic water upwelling system towed by a surface vessel.

Another embodiment includes an oceanic water upwelling system towed by a submarine vessel.

Another embodiment includes a semi-autonomous oceanic water upwelling system towed by a surface vessel.

Another embodiment includes a semi-autonomous oceanic water upwelling system towed by a submarine vessel.

Another embodiment includes an oceanic water upwelling system incorporated in a surface vessel which utilizes the upwelled water for forward propulsion rapidly mixing this water with surface waters.

### BRIEF DESCRIPTION OF THE DRAWINGS

FIG. 1 illustrates a mobile marine upwelling device towed behind a surface vessel.

FIG. 2 illustrates the detailed components of a towable mobile marine upwelling device.

FIG. 3 illustrates a mobile marine upwelling device towed behind a submersible vessel.

FIG. 4 illustrates a mobile marine upwelling system traveling adjacent to a continental shelf on the western coast of North America.

FIG. 5 illustrates a cyclonic storm traveling across the east coast of South and North America.

FIG. 6 illustrates mobile upwelling systems deployed in front of an advancing cyclonic storm approaching the east coast of South and North America and the resultant path.

FIG. 7 illustrates the path of cyclonic storm Iniki traveling through the Hawaiian Islands.

FIG. 8 illustrates mobile upwelling systems deployed in front of an advancing cyclonic storm approaching the Hawaiian Islands and the resultant path.

FIG. 9 illustrates a semi-autonomous surface marine vehicle towing an upwelling system.

FIG. 10 illustrates a semi-autonomous upwelling system wherein the towing vessel is a fully submersible marine vessel.

FIG. 11 illustrates a self-contained upwelling vessel which uses gravitational forces to propel water to the vessel and motorized propulsion to expel the water from the vessel and move the vessel forward.

FIG. 12 illustrates the propulsion details of a self-contained upwelling vessel which uses gravitational forces to propel water to the vessel and motorized propulsion to expel the water from the vessel and move the vessel forward.

FIG. 13 illustrates an upwelling vessel which uses gravitational forces to propel water to the vessel and motorized propulsion to expel upwelled water from the vessel and to move the vessel forward and allows the depth of the upwelled water to be selected by rotating the upwelling water tube.

FIG. 14 illustrates an upwelling vessel as in FIG. 13 which uses gravitational forces to propel water to the vessel and motorized propulsion to expel upwelled water from the vessel and to move the vessel forward with the upwelling tube deployed into deep waters.

FIG. 15 illustrates details of the propulsion system of an upwelling vessel as in FIGS. 13 and 14 which uses gravitational forces to propel water to the vessel and motorized propulsion to expel upwelled water from the vessel and to move the vessel forward.

### DETAILED DESCRIPTION OF EMBODIMENTS

Oceanic water upwelling devices have been conceived to enrich or cool surface or near-surface waters. These devices, however, have been either floating wherever the winds or currents take them or anchored in a single location. The embodiments of this invention transport the upwelling devices wherever they are most needed at the time they are most needed and utilize the traveling velocity or propulsion to upwell the deep water to the surface or near-surface waters. Thus, these embodiments demonstrate a clear advantage over previously conceived devices.

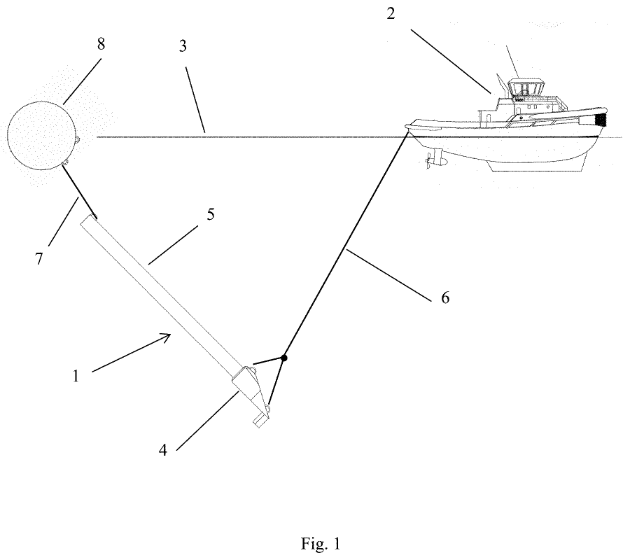

FIG. 1 illustrates a mobile upwelling device 1 being towed by a surface marine vessel 2 such as a tugboat on an ocean surface 3. The upwelling device is comprised of a weighted, funneling dive plane 4 connected to a water transport tube 5. The funneling dive plane 4 is connected to the surface marine vessel 2 by a tow line 6. The funneling dive plane 4 is also connected to a water transport tube 5 the outlet end of which is connected by a float connecting line 7 to a buoyant float 8 which keeps the water transport tube 5 outlet in or near surface waters. As the mobile upwelling device 1 is propelled forward by the surface marine vessel 2, the dive plane 4 descends deep into the ocean due to the dive angle of the funneling dive plane 4 and the water that is forced onto the weighted dive plane is propelled the water up and through the water transport tube 5 where the upwelled water is ejected into the surface or near-surface waters near the float 8 to be mixed with the near-surface waters. This mixing facilitates the use of the cool, nutrient rich deep water by marine plants and animals thereby improving the health of the oceans. Additionally, if located in the pathway of cyclonic storms, this upwelling can alter the pathway of and reduce the intensity of the storms and reduced onshore damage by cooling the surface and near-surface waters. The depth of the water, and therefore the temperature and nutrient content of the upwelled water, can be adjusted by adjustment of the length of the tow line 6 and by altering the angle of the funneling dive plane 4. For example, if the dive angle is increased, the depth from which upwelled water is brought to the surface or near-surface will be deeper. If that dive angle is decreased, this depth will be shallower.

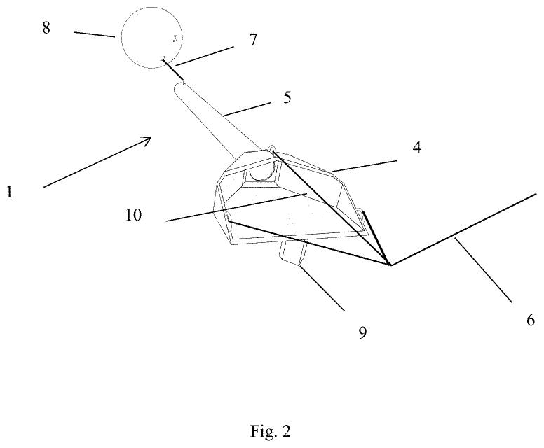

FIG. 2 illustrates, in more detail, a mobile marine upwelling device comprised of a funneling dive plane 4, including a weight 9 on the forward end of the dive plane 4 which ensures that the forward motion pushes the plane deep into the water by tipping the plane down at the forward end. A tow line 6 is connected to the dive plane 4 aft of the weight 9 and forward of the water transport tube 5 on each side of the dive plane 4 such that the plane angle is down toward deeper waters. The angle of the dive plane 4 may be altered to dive deeper while in motion by adjusting the length of the dive angle adjustment line 10. The outlet end of the water transport tube 5 is connected to the float 8 by the float connecting line 7.

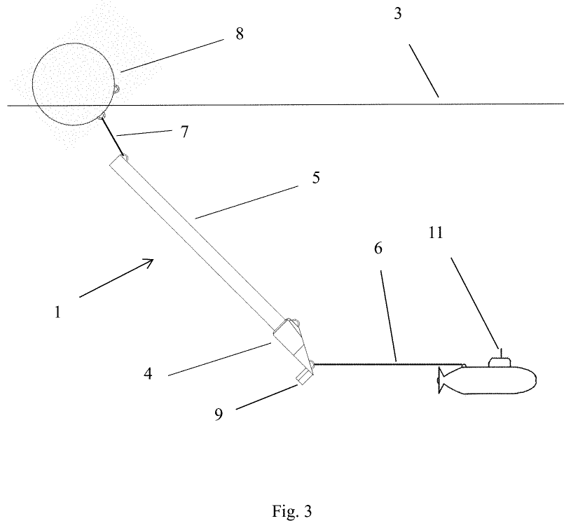

FIG. 3 illustrates a water upwelling system 1 propelled forward by a tow line 6 connected to a submersible marine vessel 11. The depth of the water upwelled toward the ocean surface 3 by this system is determined by the dive depth of the submersible vessel 11 below the ocean surface 3 and the overall length of the upwelling device 1. As such, the weight 9 on the dive plane 4 may be small or eliminated. As the submersible vessel 11 travels forward pulling the dive plane 4, the water transport tube 5, the float connecting line 7, and the float 8, cool, nutrient rich water is transported up the water transport tube 5 toward the float 8 until it exits and mixes with the surface or near-surface water.

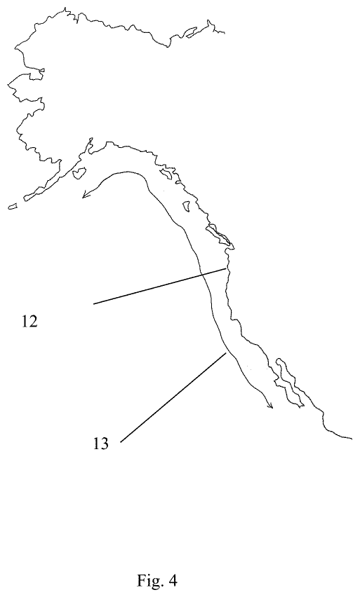

FIG. 4 illustrates how one or more towed upwelling systems (not shown may be deployed along the coastal waters of a country or continent to enrich or cool the adjacent coastal shelf waters. The North American west coast 12 is illustrated along with a representative vessel path 13 that an upwelling vessel or fleet of vessels (not illustrated) may take. This system may be deployed in deep water very near the edge of the continental shelf to bring up nutrient rich water from 100 meters depth or more so the nearby coastal marine biome will benefit from this enrichment. In some cases, the upwelled water may still be lacking in ideal nutrients. In such a case, nutrients, such as iron, may be dispersed by the vessel along the route in areas where such nutrients are needed.

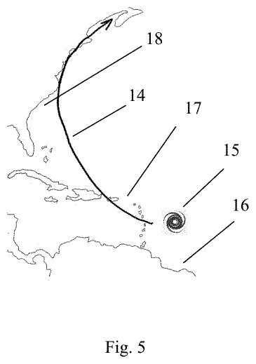

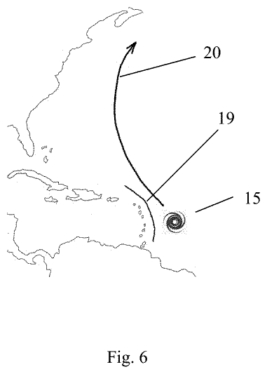

FIGS. 5 and 6 illustrate how one or more mobile upwelling devices (not shown) could travel in front of, or in the likely path of, a cyclonic storm cooling the surface and near-surface water to reduce the intensity of the storm or, perhaps, to redirect the storm away from vulnerable onshore populations. FIG. 5 illustrates the storm path 14 an oceanic cyclonic storm 15 would likely take along the northeast coast of South America 16, through Caribbean islands 17, and pummeling part of the east coast of North America 18 potentially causing much human and property damage. FIG. 6 illustrates a potential route 19 that one or more mobile upwelling vessels could take that could reduce the damage from the cyclonic storm 15 and the potential resultant path 20 of cyclonic storm 15, which would be deflected away from vulnerable shores.

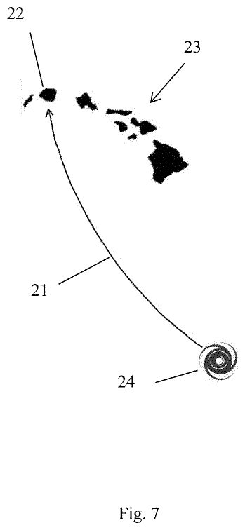

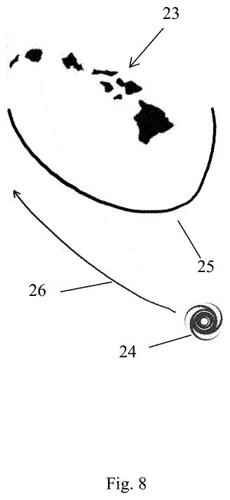

FIGS. 7 and 8 also illustrate how a mobile upwelling device may provide needed benefit. FIG. 7 illustrates the approximate cyclonic storm path 21 of hurricane Iniki 24 which, in 1992, devastated the island of Kauai 22 in the Hawaiian archipelago 23 causing over 3 billion dollars in damage.

FIG. 8 illustrates how creating a cool water barrier by upwelling cool water along a route 25 could have potentially altered the path 26 of a cyclonic storm 24, such as Iniki, that it could completely miss the Hawaiian Island archipelago 23.

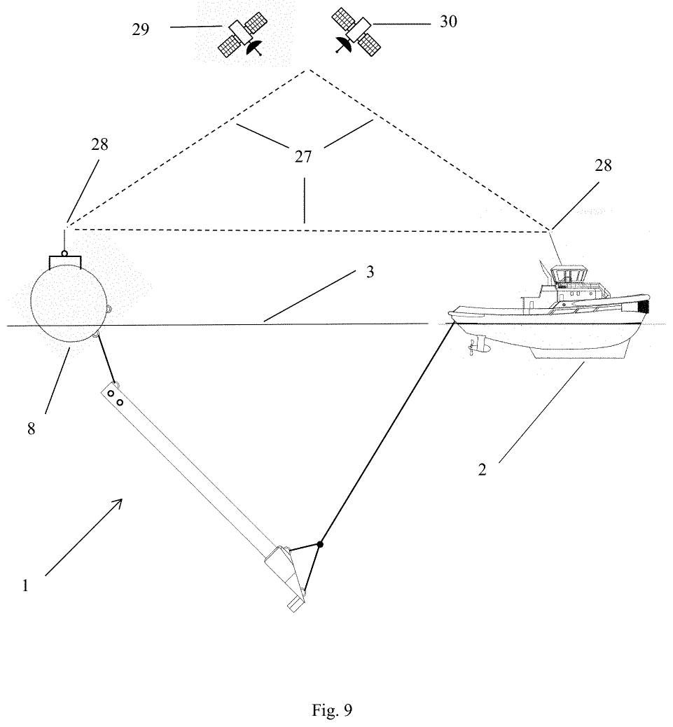

FIG. 9 illustrates a semi-autonomous upwelling system. The system includes communications 27 (shown as dashed lines) between antennae 28 on the float 8, a surface marine vessel 2 and communication satellites 29 and GPS satellites 30 as well as between the float 8 and the surface marine vessel 2 such that a remote operator (not illustrated) can alter the course, or speed of the upwelling system as needed. In this instance, the towing vessel 2 can communicate with both the GPS satellites 29 and, the communication satellites 30 to determine the position and course of the cyclonic storm, the position and course of the upwelling system, and if needed, relays course and speed commands from a remote, onshore controller (not illustrated). The float 8 also can have communication with the water transport tube 5 which can transmit upwelling data from sensors (not shown) within the water transport tube 5 such as upwelled water temperature, flow rate, and water chemical composition back to the controller (not shown) or to the surface marine vessel 2. When deployed near severe storms, the amount of buoyancy of the float 8 may be altered to protect it from storm damage.

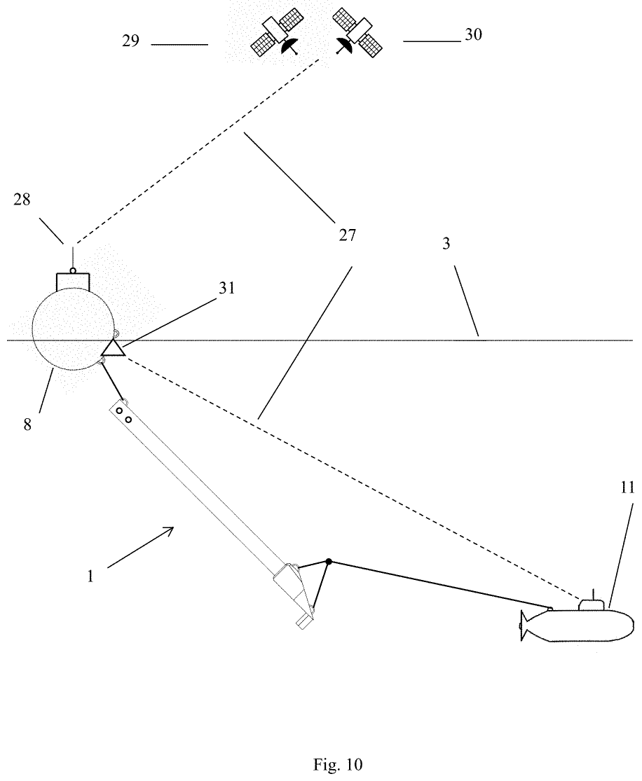

FIG. 10 illustrates a semi-autonomous upwelling system, wherein the towing vessel is a fully submersible marine vessel 11. In this case, since the submersible marine vessel 11 cannot communicate directly with satellites because it is not on the surface. Communication satellite(s) 30 and GPS satellite(s) 29 use communications 27 (shown in dashed lines) by way of antenna 28 which relays to a bidirectional underwater communication system 31 on the float 8 directly which, in turn relays course correction information to the submersible marine vessel 11. Thus, a remote onshore controller can monitor and guide the upwelling system. Clearly such semi-autonomous systems could be converted to fully autonomous if proven reliable and effective enough. Because of the risk to vessel operators involved in deployment in the vicinity of potentially fatal storm systems, a semi-autonomous or fully autonomous system could be the system of choice for such storm abatement.

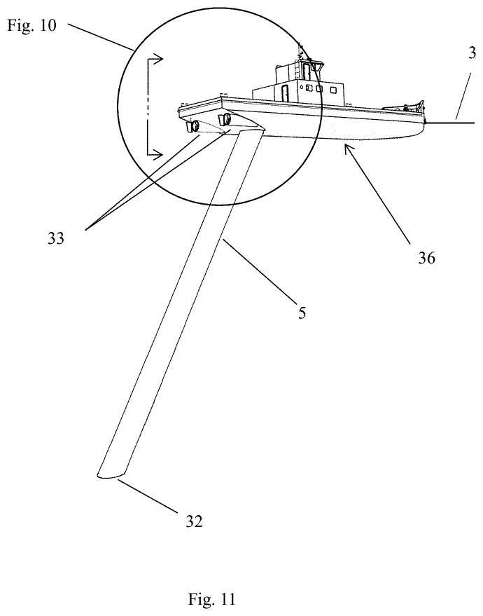

FIG. 11 illustrates a surface upwelling vessel 36 in which gravitational forces propel the water from the water transport tube input end 32 through the water transport tube 5 to the surface upwelling vessel 36. Once the upwelled water reaches the vessel hull, water is thrust out through the propulsion tubes 33 in the stern of the vessel below the water line 3.

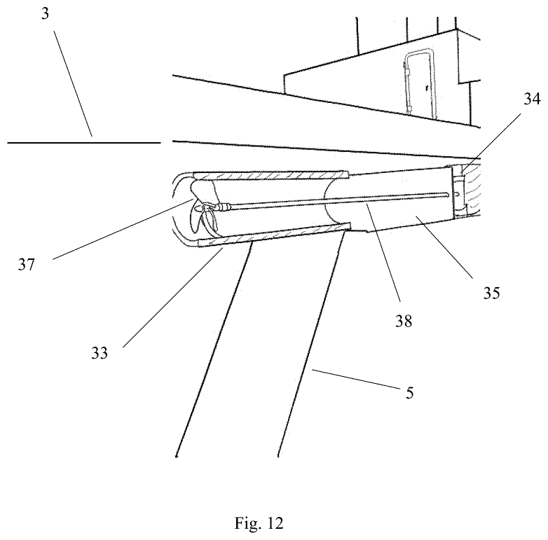

FIG. 12 illustrates, in a more detailed cross-section view of the aft portion of the vessel through the starboard propulsion tube 33 shown in FIG. 11, showing how the upwelled water is used to propel the vessel forward by motors 34 which turn the drive shafts 38 and the propellers 37 within the propulsion tubes 33. The upwelled nutrient rich, cool water is brought into the propulsion water storage chamber 35 by gravitational forces since this chamber is below the vessel water line 3 and conducted into the propulsion water storage chamber by the water transport tube 5 and then forced out through the propulsion tubes 33 by the propellers at a high flow rate. Thus, the upwelled water propels the vessel on the desired route as well as mixes the upwelled water with the surrounding surface waters due the turbulence caused by the thrust.

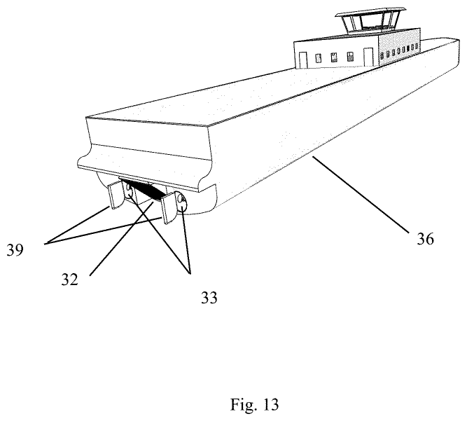

FIG. 13 illustrates a mobile upwelling vessel 36 wherein the upwelling water transport tube can be pivoted or rotated to upwell from a desired depth. This embodiment also provides a telescoping mechanism for the upwelling tube to enable reaching deeper waters. In this illustration, the upwelling tube is in a position wherein the upwelling tube has not been rotated or telescoped and the propulsion water is acquired from the water transport input end 32 located near the ocean surface. The output from the propulsion tubes 33 is located just aft of the water transport input end 32. The propulsion water travels forward through the upwelling transport tube, into the propulsion water storage chamber, out through the propulsion tubes, and past the rudders 39 thereby propelling the vessel forward.

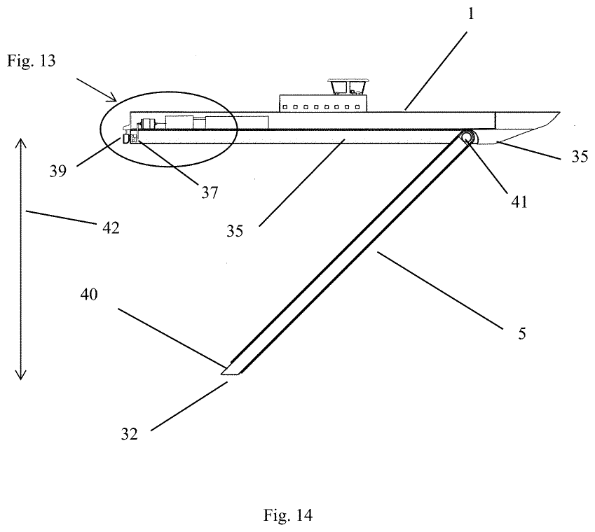

FIG. 14 illustrates the mobile upwelling vessel of FIG. 13 wherein the upwelling water transport tube 5 has been rotated about the pivot port 41 such that the water transport tube input end 32 is located at a desired depth 42. The cool, nutrient rich, water is transported by the force of gravity through the water transport tube input end 32 of the telescoping tube 40, through the pivoting water transport tube 5, through the pivot port 41 and into the propulsion water storage chamber 35. This propulsion water storage chamber 35 brings the water aft to the propulsion tubes (not shown) where the propellers 37 force water out propelling the vessel forward. Steering of the forward motion of the vessel 1 is accomplished by rotation of the rudders 39.

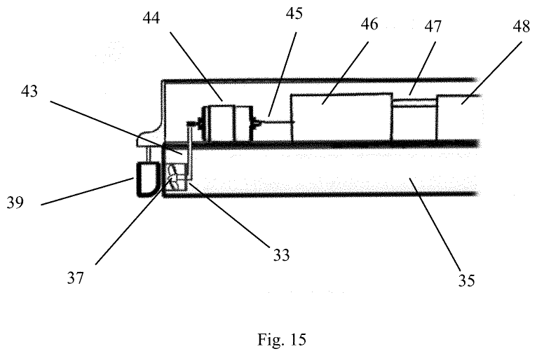

FIG. 15 further illustrates the upwelling propulsion system shown in FIG. 14. In this case, electric motors are used to provide the torque need for propulsion and upwelling. Fuel such as compressed hydrogen, stored in the fuel storage chamber 48 is conducted to the generators 46 through fuel lines 47. These generators 46 provide electric power through power cables 45 to electric motors 44. The torque output of the electric motors 44 is coupled to the propellers 33 by articulated drive shafts 43 turning the propellers 37 forcing the water from the propulsion water storage chamber 35 out through the propulsion tubes 33. Vessel steering is accomplished by rudders 39. Other sources of the required torque could be used.

What is claimed is:

1. A mobile marine water upwelling system wherein cool, nutrient rich water is propelled from depths by the forward motion while being pulled by a marine vehicle including a dive plane which funnels water to a transport tube connected to a surface or near-surface buoyancy.

2. A mobile marine water upwelling system as in claim 1 wherein the marine vehicle is a surface vehicle.

3. A mobile marine water upwelling system as in claim 1 wherein the marine vehicle is a submersible vehicle.

4. A mobile marine water upwelling system as in claim 1 wherein the outlet of the cool water is mixed with and dispersed into surface or near-surface water.

5. A mobile marine water upwelling system as in claim 1 wherein the course of the vehicle and upwelling system is monitored and controlled remotely using data to and from global positioning satellites and communication satellites.

6. A mobile marine water upwelling system as in claim 1 wherein the device contains technology to mix the upwelled water with the surface or near-surface waters.

7. A mobile self-propelled upwelling system as in claim 1 wherein the system includes a weighted dive plane which funnels water to a transport tube connected to a surface or near-surface buoyancy.

8. A mobile self-propelled upwelling system as in claim 7 wherein dive plane angle is adjustable.

9. A mobile marine water upwelling system as in claim 3 wherein the float buoyancy or depth of upwelled water is remotely controlled by the towing vessel or by a remote controller.

10. A mobile marine water upwelling system wherein the upwelled water provides the thrust for the system mobility.

11. A mobile marine water upwelling system as in claim 10 wherein a pivoting water transport tube is rotated to select the depth of the upwelled water.

12. A mobile marine water upwelling system as in claim 11 wherein the pivoting water transport tube is a telescoping tube.

13. A method of improving the marine biome of a region by upwelling nutrient rich water using a mobile marine water upwelling device traveling nearby to the region.

14. A method of modifying the intensity or course of a marine cyclonic storm by upwelling cool water from oceanic depth using a mobile upwelling system to cover large oceanic surface areas.

15. A method of modifying the intensity or course of a marine cyclonic storm as in claim 14 wherein the course, speed, or depth of the mobile upwelling is monitored and controlled remotely using satellite communications.
